(19) United States
(12) Patent Application Publication
(10) Pub. No.: US 2009/0271571 A1
(43) Pub. Date: Oct. 29, 2009

(54) STORAGE SERVER

(75) Inventors: Chun-Liang Lee, Tu-Cheng (TW); Shu-Hsien Chou, Tu-Cheng (TW); Chi-Chung Huang, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Taipei Hsien (TW)

(21) Appl. No.: 12/180,226

(22) Filed: Jul. 25, 2008

(30) Foreign Application Priority Data
Apr. 28, 2008 (CN) 200820300634.9

(51) Int. Cl. G06F 12/00

(52) U.S. Cl. 711/114; 711/E12.001

(57) ABSTRACT

A storage server includes a plurality of first disk drives (110) and a plurality of second disk drives (210). Each first disk drive is of a same type. The first disk drives are connected in series. Each second disk drive is of a same type different from each first disk drive. The controller includes a disk drive identifying module (62) and at least one disk drive controller module 64 connected to the disk drive identifying module. The at least one disk drive controller module includes a first disk drive controller module (64) and a second disk drive controller module. The first disk drive controller module is capable of processing a first signal outputting from the first disk drives. The second disk drive controller module is capable of processing a second signal output from a plurality of second disk drives of different type from the first disk drives. The disk drive identifying module is capable of identifying the first signal and the second signal from an input signal and outputting the first signal or the second signal to the corresponding first disk drive controller module or the second disk drive controller module.

### BACKGROUND

1. Technical Field

The present invention relates to a storage server, especially to a storage server which is adapted to receive different types of hard disks.

2. Description of Related Art

Storage servers are used for storing massive amounts of data for backup. A storage manner named Just a Bunch of Disks (JBOD) is generally used in storage servers. This manner uses a plurality of storage cells connected in series in one server chassis to act as a single large storage device.

The storage cells in a storage server are usually hard disks such as found in desktop computers. There are many types and sizes of hard disks. The two most common types of hard disks used in the storage servers are: 3.5 inch hard disks and 2.5 inch hard disks. To some degree, these two types of hard disks are all needed in different storage server, and these two types of hard disks may need two different types of chassis with different size. Typically, a controller board of the storage server can only process one type of hard disk, and extra controller board to process a different type of hard disk could be further needed.

### BRIEF DESCRIPTION OF THE DRAWINGS

FIG. 1 is an isometric assembled view of the storage server assembled with a first disk drive assembly;

FIG. 2 is an isometric assembled view of the storage server assembled with a second disk drive assembly;

FIG. 3 is a schematic working block view of FIG. 1;

FIG. 4 is a schematic working block view of FIG. 2; and

FIG. 5 is a schematic working block view of a controller of the present invention.

### DETAILED DESCRIPTION OF THE EMBODIMENT

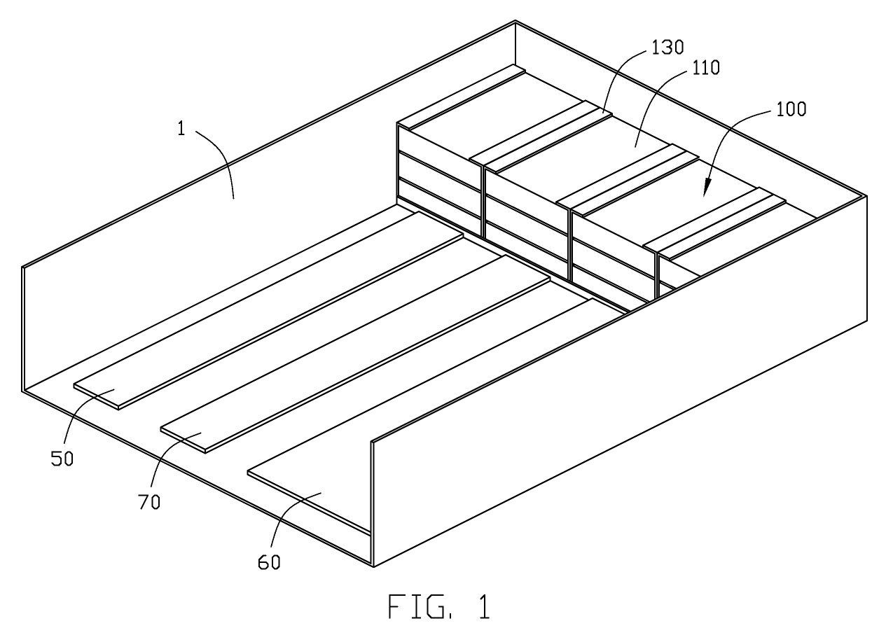

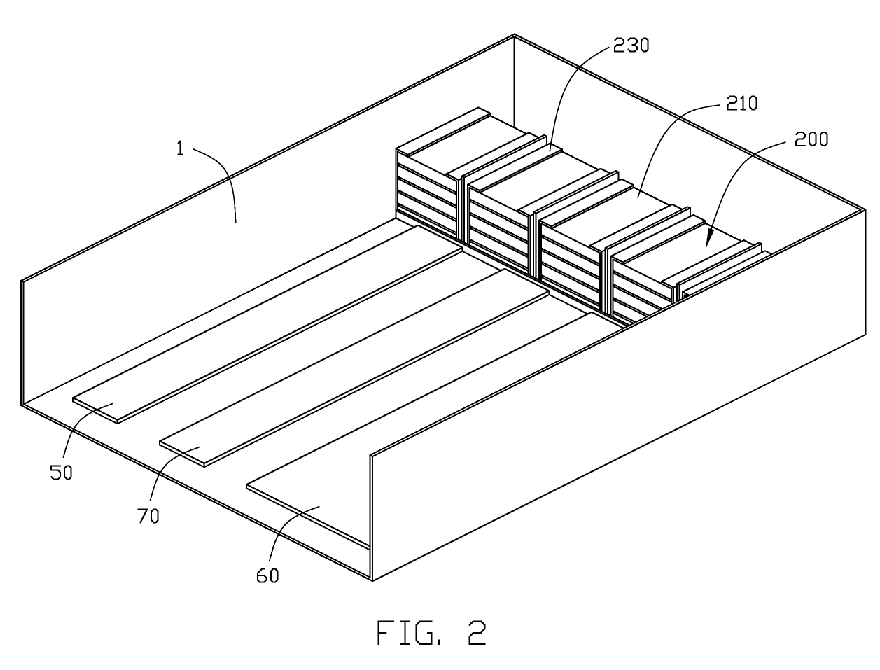

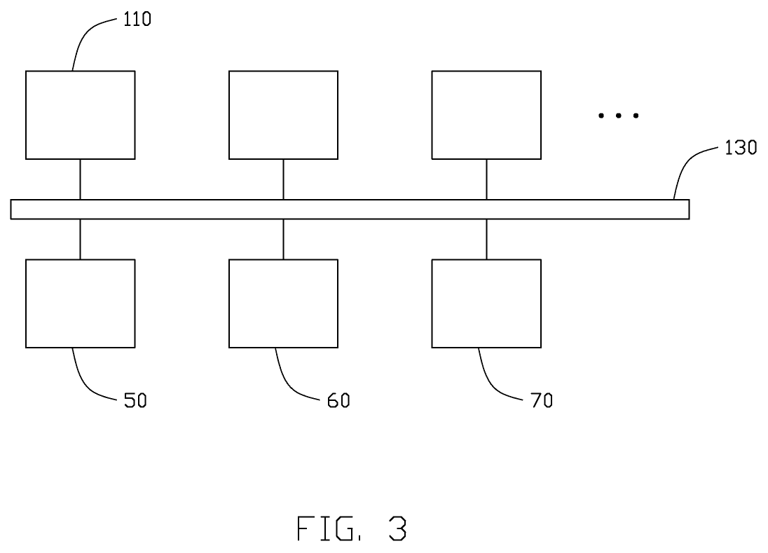

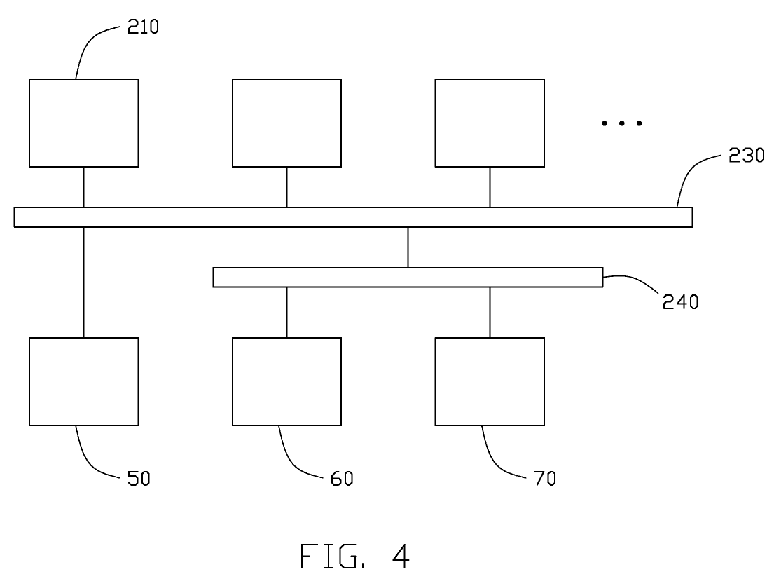

Referring to FIGS. 1 through 4, a storage server can alternatively receive a first disk drive assembly 100 or a second disk drive assembly 200 in a chassis 1. The first disk drive assembly 100 includes a plurality of first disk drives 110 connected in series and a first bracket 130 for receiving the first disk drives 110. The second disk drive assembly 200 includes a plurality of second disk drives 210 connected in series and a second bracket 230 for receiving the second disk drives 210. The first disk drive 110 is different than the second disk drive 210. The chassis 1 has at least one power supply 50, heat sink 70, and controller 60 assembled therein. The at least one power supply 50 is capable of providing power to the first disk drives 110 or the second disk drives 120. The at least one heat sink 70 is capable of dissipating heat from the first disk drives 110 or the second disk drives 120. The chassis 1 further has a riser board 240 detachably fixed thereon for connecting the second disk drive assembly 200 to the controller 60 and the heat sink 70.

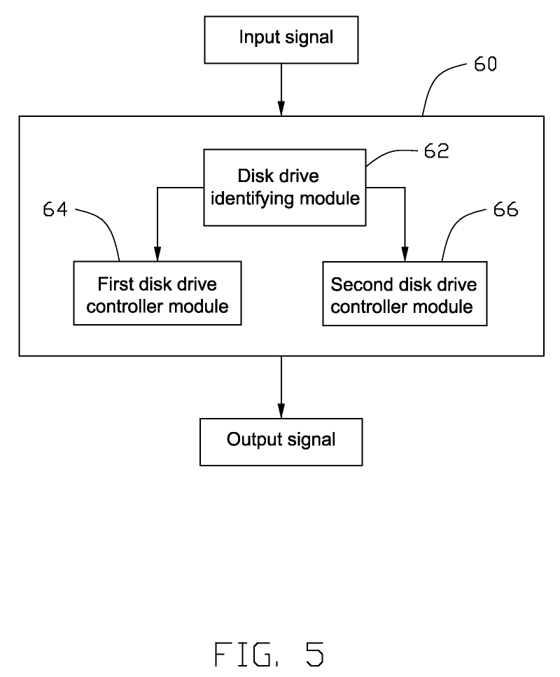

Referring to FIG. 5, the controller 60 is integrated to a board, and it is used for managing the disk drives and presents them to the storage server as logical units. The controller 60 includes a disk drive identifying module 62, a first disk drive controller module 64, and a second disk drive controller module 66. The first disk drive controller module 64 and the second disk drive controller module 66 are connected to the disk drive identifying module 62. When the controller 60 is connected to one of the disk drive assembly 100 or 200, the controller 60 can first identify an input signal of the disk drive, and then process the input signal with the corresponding controller module. The first disk drive controller module 64 or the second disk drive controller module 66 may use one of the following interface methods: Integrated Drive Electronics (IDE)/Advanced Technology Attachment ATA, Serial Advanced Technology Attachment (SATA), Small Computer System Interface (SCSI), Serial Storage Architecture (SSA), or Fibre Channel for supporting different types of disk drives.

The storage server has the following advantages: the controller 60 is adapted to work with two or more (if needed) types of disk drives respectively which are installed in the same chassis, so no extra controller is needed in the storage server for adapting to the different types of disk drives, and there is no need to change the chassis and controller when changing to another type of disk drives.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A storage server comprising:
a plurality of first disk drives of a first type connected in series;
a plurality of second disk drives of a second type connected in a series; and
a controller comprising a disk drive identifying module and at least one disk drive controller module connected to the disk drive identifying module, and the at least one disk drive controller module comprising a first disk drive controller module being capable of processing a first signal output from the first disk drives, and a second disk drive controller module being capable of processing a second signal output from the plurality of second disk drives, wherein the disk drive identifying module is capable of identifying the first signal and the second signal from an input signal and outputting the first signal or the second signal to the corresponding first disk drive controller module or the second disk drive controller module.

2. The storage server as claimed in claim 1, wherein the storage server further comprises a heat sink, and the heat sink is capable of dissipating heat from the first disk drives.

3. The storage server as claimed in claim 1, wherein the storage server further comprises a power supply, and the power supply is capable of providing power to the first disk drives and the second disk drives.

4. The storage server as claimed in claim 1, wherein the storage server further has a riser board detachable thereon, and the riser board is capable of connecting the second disk drives to the controller.

5. The storage server as claimed in claim 1, wherein the first disk drive controller module or the second disk drive controller module uses one of following controlling forms: Integrated Drive Electronics (IDE)/Advanced Technology Attachment ATA, Serial Advanced Technology Attachment (SATA), Small Computer System Interface (SCSI), Serial Storage Architecture (SSA), or Fibre Channel for supporting corresponding disk drives.

6. A controller comprising:
a disk drive identifying module; and
two or more drive controller modules connected to the disk drive identifying module, the disk drive controller modules comprising a first disk drive controller module being capable of processing a first signal and a second disk drive controller module being capable of processing a second signal, and the first signal and the second signal being output from two different types of the disk drives, wherein the disk drive identifying module is capable of identifying the first signal or the second signal and outputting the first signal or the second signal to the corresponding disk drive controller module.

7. The controller as claimed in claim 6, wherein the controller is capable of managing a plurality of physical disk drives as well as different types of physical hard drives and presents them to the storage server as logical units.

8. The controller as claimed in claim 6, wherein the first disk drive controller module or the second disk drive controller module use one of following controlling forms: Integrated Drive Electronics (IDE)/Advanced Technology Attachment ATA, Serial Advanced Technology Attachment (SATA), Small Computer System Interface (SCSI), Serial Storage Architecture (SSA), and Fibre Channel for supporting corresponding disk drives.
